(19) United States
(12) Patent Application Publication
(10) Pub. No.: US 2013/0026238 A1
(43) Pub. Date: Jan. 31, 2013

(54) HYBRID CONTACT-CONTACTLESS SMART CARD WITH REINFORCED ELECTRONIC MODULE

(71) Applicant: Pierre BENATO, Roquefort Les Pins (FR)

(72) Inventor: Pierre BENATO, Roquefort Les Pins (FR)

(21) Appl. No.: 13/547,827

(22) Filed: Jul. 12, 2012

(30) Foreign Application Priority Data
Jul. 12, 2011 (FR) FR11/02195

(51) Int. Cl. G06K 19/077

(52) U.S. Cl. 235/492

(57) ABSTRACT

A hybrid contact-contactless smart card (1) including a card body made up of a plurality of layers. Supporting layer (40) supports printed antenna (41) made up of at least one turn and integrated circuit module (10) connected to the antenna by two internal and external contacts (43, 44) located in the continuation of the internal and external ends (45, 46), respectively, of the antenna turns, the module being located on the card in a portion defined by first side (6), second side (8) perpendicular to the first side, first line (3) parallel to the first side (6) and second line (4) parallel to the second side. Internal end (45) of the antenna turns is located entirely in the portion such that when the card is subjected to bending and/or twisting stresses, the connection between the module and the antenna is not cut.

### TECHNICAL FIELD

The present invention concerns contactless radiofrequency identification (RFID) devices and specifically concerns a hybrid contact-contactless smart card with reinforced integrated circuit module and its manufacturing process.

### BACKGROUND ART

A contactless RFID device is a device consisting of an antenna and an integrated circuit connected to the terminals of the antenna. Usually, the integrated circuit is not powered and receives its energy through electromagnetic coupling between the reader's antenna and the antenna of the RFID device; information is exchanged between the RFID device and the reader and, in particular, the information stored in the integrated circuit related to the identification of the holder of the object on which are located the RFID device and the holder's authorisation to enter a controlled access zone.

A hybrid contact-contactless smart card is a contactless RFID device except that the exchange of data with the reader can also take place by contact on the flush and conductive contact areas of the card connected to the integrated circuit. The integrated circuit is thus encapsulated in the module, the external face of which comprises the flush contact areas. The integrated circuit is also connected to the internal face of the module designed to connect to the card's antenna. Thus, the integrated circuit is connected to the two faces of a double-face module to form, once encapsulated, a double-face integrated circuit module or a double-face electronic module. As a result, the strength of the electronic module, and thus the integrated circuit on the card, is weakened in relation to contactless integrated circuit card where the integrated circuit is most often encapsulated in the card body. The major problem of hybrid contact-contactless smart cards is thus their fragile nature. Furthermore, the module is a rigid element that does not bend. As a result, the stresses are concentrated around the module, particularly along its internal edges located nearest the axes of symmetry of the card, thus the centre of the card. Usually, the process for manufacturing hybrid contact-contactless smart cards comprises the following steps:
a step for manufacturing the antenna on a support,
a step for laminating card bodies onto the antenna support consisting in welding, on each side of the support, one or several sheets of plastic material, forming the card bodies, by a hot press moulding technique,
a step for milling cavities consisting in piercing, in one of the card bodies, a cavity designed to house the module formed by the integrated circuit and the double-sided circuit, the cavity comprising a smaller internal portion that receives the integrated circuit and a larger external portion that receives the double-sided module, the milling step enabling the contacts of the antenna to be mill relieved, and
a module insertion step consisting in using a glue to secure the module and an electrically conductive glue to connect the module to the contacts and to position it in the cavity provided for this purpose.

The hybrid contact-contactless smart cards are subjected to bending and twisting tests according to the criteria defined in the current standard. A first type of hybrid contact-contactless smart card is a one-piece card in which the plastic antenna support is inserted between two layers of plastic material forming the upper and lower card bodies and heat bonded by hot-lamination under pressure. The module is connected to the antenna by an electrically conductive glue or equivalent which enables the ohmic contact to be established.

This type of card is very rigid. As a result, when this type of card is subjected to mechanical bending and/or twisting stresses, the stresses do not mark the card but causes it to break along the axes under the greatest amount stress, i.e. along the module.

Another type of card is equipped with a break-resistant paper antenna support. This type of card has a drawback since the electronic module is not firmly secured on the card. Indeed, an antenna support made of fibrous material such as paper offers the advantage of “memorizing” the bends of the card, although the card lacks internal cohesion promoting, after multiple bends, delamination of the paper under the glue joints holding the module onto the card and thus vertically in relation to the thinner part of the card body, thereby causing the disconnection of the electronic module and the antenna. Usually, the first contact of the module that disconnects from the antenna is the one located nearest the centre of the card.

### SUMMARY OF THE INVENTION

This is why the purpose of the invention is to provide a hybrid contact-contactless smart card that counters these drawbacks, i.e. that is able to withstand bending tests without the card body breaking or the connection between the module and the antenna breaking.

Another purpose of the invention is to provide a method for manufacturing such a device.

The purpose of the invention is thus a hybrid contact-contactless smart card comprising a card body made up of a plurality of layers, one of the layers of which, referred to as the supporting layer, supports a printed antenna made up of at least one turn and supports an integrated circuit module connected to the antenna by two internal and external contacts located in the continuation of the internal and external ends of the antenna turns, respectively, the module being located on the card in a portion defined by a first side of the card, a second side of the card perpendicular to the first side, a first line parallel to the first side of the card and a second line parallel to the second side of the card. According to the main characteristic of the invention, the internal end of the antenna turns connected to the internal contact is located entirely in the portion in such a way that when the card is subjected to bending and/or twisting stresses, the connection between the module and the antenna is not broken. Furthermore, the contacts are made by printing of at least two layers of an electrically conductive ink onto the support, the first layer of ink including spaces not covered with ink.

### BRIEF DESCRIPTION OF THE DRAWINGS

The purposes, objects and characteristics of the invention will become more apparent from the following description when taken in conjunction with the accompanying drawings in which:

FIG. 1 is a top view of a hybrid contact-contactless smart card,

FIG. 2 represents a section of a double-sided electronic module according to prior art,

FIG. 3 represents the double-sided electronic module according to prior art, as seen from the side of the integrated circuit,

FIG. 4 is a top view of the antenna support of the hybrid contact-contactless smart card according to the invention,

FIG. 5 is a cross-section of the various component layers of the card according to the invention,

FIG. 6 represents a cross-section of the card according to the invention, equipped with its module,

FIG. 7 represents a transparent top view of the module and the antenna contacts according to the invention.

### DETAILED DESCRIPTION OF THE INVENTION

Generally speaking in the description that follows, the term “internal” edge or side refers to the edges and the sides of an element located geometrically closer to the centre of the card than the edges or the sides opposite the same element designated by the term “external”.

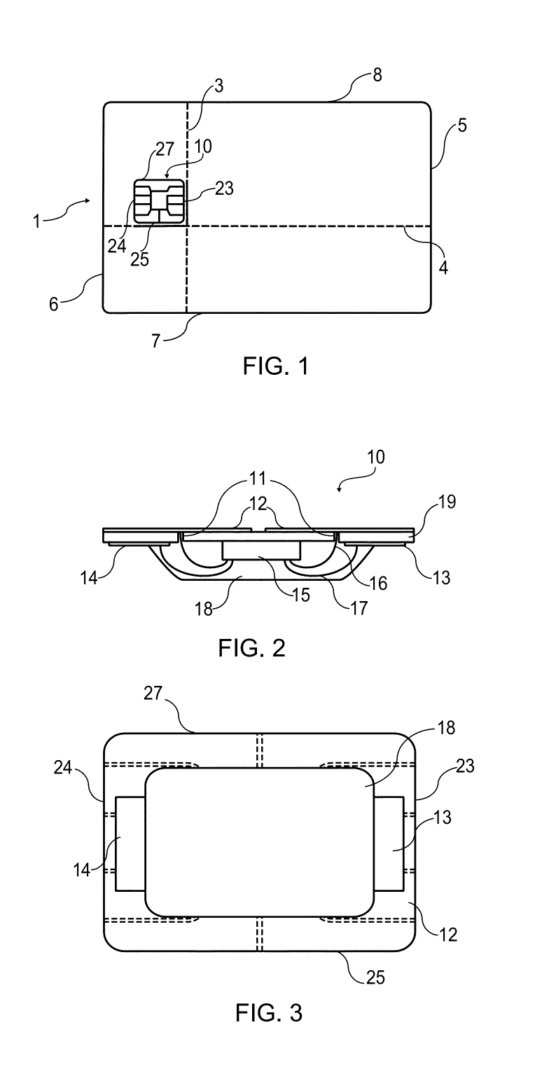

According to the illustration of FIG. 1, a hybrid contact-contactless smart card 1 is equipped with a module 10. The external dimensions of the card correspond to the “credit card” format defined in standard ISO 7810. The card includes two short sides 5 and 6 perpendicular to two long sides 7 and 8. The module 10 includes two short edges 23 and 24 and two long edges 25 and 27. During mechanical tests and particularly during the bending test of the card, the axes of the card under the most stress, i.e. where the stresses are the greatest, are represented by the dashed lines 3 and 4. The lines 3 and 4 located along the internal edges 23 and 25 of the module are parallel to sides 6 and 8 of the card, respectively. The rupture zones of the card are located on these lines 3 and 4 on the continuous line along the internal edges of the module. The module is located on the card in a portion defined by a first side 6 of the card, a second side 8 of the card perpendicular to the first side 6, the line 3 and a second line 4.

According to FIG. 2, the device according to the invention includes an electronic module 10 made up of an electrically non-conductive support 19 having, on its first face, the flush contact areas 12 adapted to connect to the contacts of the reading head of the reading device, and on the other face, contacts 13 and 14 adapted to be connected to the antenna of the card. An integrated circuit 15 is then connected to both the flush contact areas 12 by means of soldered gold wires 16 passing through the support via holes 11 provided for this purpose and to the contacts 13 and 14 adapted to also be connected to the antenna by soldered gold wires 17. The integrated circuit 15 and the wires 16 and 17 are then protected and encased by resin 18 poured from above. When the resin has hardened, the integrated circuit and the wires are then encapsulated and only a part of the contacts 13 and 14 intended to connect to the antenna contacts is visible as illustrated in FIG. 3. The contacts 13 and 14 of the module 10 are located on either side of the resin 18 and are parallel to the short edges 23 and 24, respectively, of the module 10. Such a module is referred to as a double-sided integrated circuit module as it includes contacts on both sides, unlike a single-sided integrated circuit module, made up solely of the flush contact areas, used in the manufacture of contact smart cards. The module is rigid so that it does not bend when the card is subjected to bending and twisting stresses. The connections between the integrated circuit 15 and the contacts 12, 13 and 14 are thus protected from breakage.

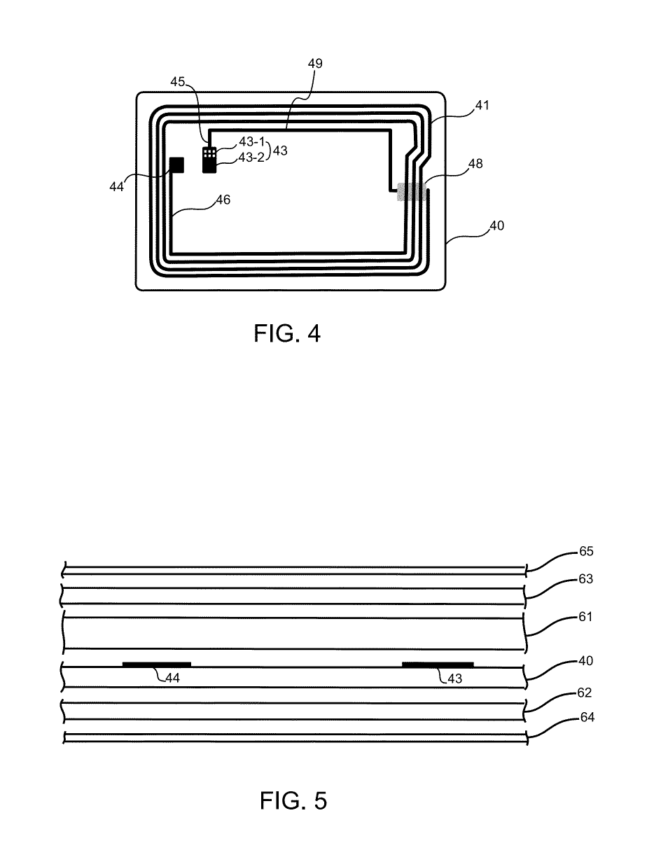

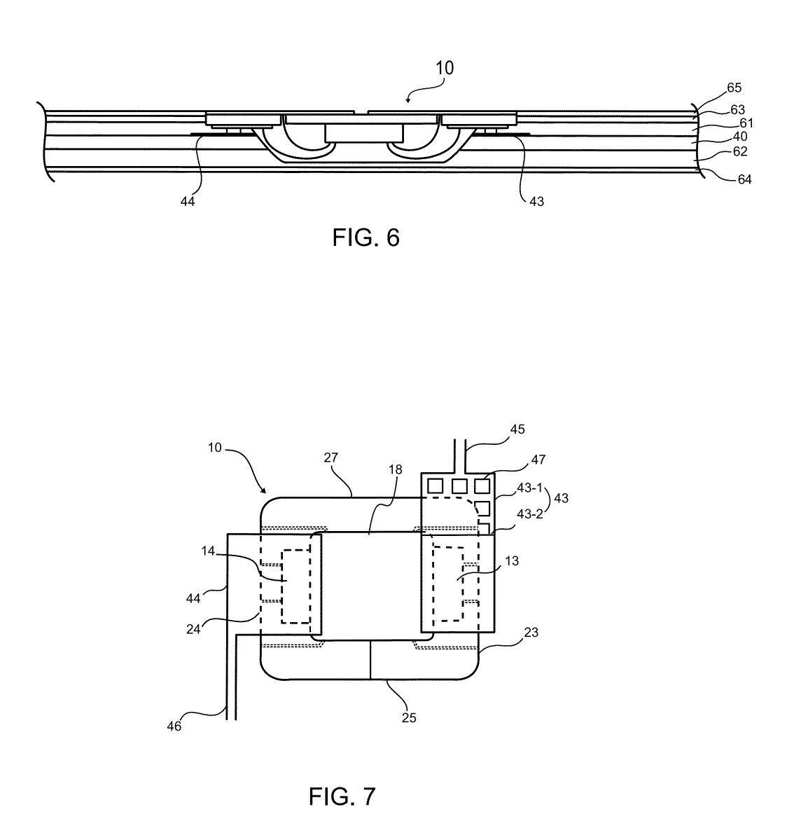

According to FIG. 4, an antenna 41 is made on a support layer 40. The antenna 41 is formed by a plurality of turns made of an electrically-conductive material. The turns, effectively rectangular in shape, include several straight portions in order to run along the edges of the card. The antenna turns cross at an insulating bridge 48. The turns feature two ends 45 and 46 forming straight antenna portions extended by two contacts 43 and 44 respectively intended to be electrically connected to two contacts 13 and 14 of the module. The two ends 45 and 46 of the antenna turns are referred to as the internal and external ends, respectively. The turns and the contacts of the antenna are made by a silk screen printing, flexography, rotogravure, offset or inkjet printing process using conductive ink such as epoxy ink doped with conductive elements such as silver or gold or a conductive polymer. The supporting layer 40 is preferably made of a material that does not creep (i.e. that does not deform as the temperature rises) such as paper or synthetic paper (Teslin type).

The internal end 45 of the antenna turns is located on the support so as not to cross the line 3. Thus, the portion of turn 49 that extends the end 45 crosses the line 3 being as far away as possible from the internal edge 23 of the module. This configuration thus places the end 45 as far away from the rupture zone as possible. The intersection of the portion of turn 49 and the line 3 must thus be located as close as possible to the edge of the card, while accounting for the location of the other antenna turns. The internal contact 43 located as close as possible to the centre of the card is most mechanically stressed when the card is subjected to bending tests around the transversal axis of symmetry of the card. The external contact 44 located near the edge 6 of the card undergoes little mechanical stress. According to the invention, the two contacts 43 and 44 are manufactured by printing of at least two layers of ink on the antenna support 40. The component layers of ink of the external contact 44 overlap one another and are all the same shape and dimensions. The dimensions of the contact 44 are such that its internal surface area widely covers the surface area of the contact 14 of the module 10. More precisely, the surface area of the contact 44 is at least equal to two times the surface area of the contact 14 of the module 10. The component layers of ink of the contact 43, designated by layer 43-1 and 43-2, overlap each other and are not all the same dimensions. The surface area of the first layer of ink 43-1 of contact 43 is larger than the surface area of the successive layers of ink. The second and following layers of the first component layer 43-1 of said contact 43 have the same surface area as that of the component layers of the contact 44. The first layer of ink 43-1 of the contact 43 is pierced. According to the preferred embodiment of the invention, the layer of ink 43-1 is produced in the form of a meshing whose meshes have spaces 47 where there is no ink. These spaces may be of different shapes without deviating from the scope of the invention. Such configuration of the first layer provides a better adherence of the second layer onto the support by adhering some ink from the second layer directly on the antenna support through spaces 47 in the first layer, thus preventing the delamination of the ink layers that make up the contact. The surface area of the second layer of ink 43-2 is less than that of the layer of ink 43-1 and is equal to the surface areas of the layers of ink of the contact 44. Once all the layers of ink are overlapped, the thickness of the antenna contacts is between 50 μm and 80 μm.

The card according to the invention includes a plurality of layers as shown in a cross-sectional view in FIG. 5. As the figure is not to scale, only the two contacts 43 and 44 are represented. A polyvinyl chloride (PVC) layer 61, a layer of polyesters (PET) 63 and a covering layer 65 are placed, in this order, on the antenna supporting layer 40 and more precisely, on the face of the layer 40 where the antenna is made. A layer of PET 72 and a covering layer 64 are placed, in this order, on the other face of the antenna supporting layer 40.

The lamination step consists in stacking all the layers 40, 61, 63, 65, 62 and 64 and subjecting them to a heat treatment at a temperature in the order of 150° C. under a pressure in the order of 20 bar. Under the effect of pressure and temperature, the layer of PVC 61 softens and encompasses the antenna turns and the antenna contacts 43 and 44. The two layers of PET stiffen the assembly and particularly the non-pierced layer of PET 62 of the cavity in which the module is housed. This configuration of component layers of the card has the advantage of providing the card both with resistance and flexibility so that the card does not break during the bending and/or twisting tests.

The following step consists in milling a cavity meant for receiving the module 10 and for gluing the module in the cavity.

In transparency in FIG. 7, the module 10 can be seen when it is in the position connected to the antenna contacts. The contacts 43 and 44 overlap contacts 13 and 14 of the module 10. The ends 45 and 46 of the antenna turns are parallel to the short sides 23 and 24 of the module and perpendicular to the long sides 25 and 27 of the module. As a result, the ends 45 and 46 of the antenna turns do not cross the rupture area of the card, i.e. the area where the bending stresses are maximum. If the end 45 of the antenna turns were extended along their axis, (according to the figure and the embodiment described, this axis is a straight line), it would cross the surface area defined by the module. The axis of the end 45 and the contact 43 are configured so that they cross the module 10 by cutting its long external edge 27.

This configuration of the end of the antenna turns allows the antenna to be moved away from the rupture area located along the edge 23 of the module. In addition, the end 45 is located in the continuation of the part of the internal contact 43 located inside the module. In this manner, the end 45 of the antenna turns does not run the risk of being cut when the card is subjected to mechanical bending stresses.

The contact 44 extends past the module on the side of its small external edge 24. The surface area of the first layer of ink 43-1 extends past the module on the side of its internal edge 23 and its long external edge 27.

1. A hybrid contact-contactless smart card (1) comprising a card body made up of a plurality of layers, one of the layers of which, referred to as the supporting layer (40), supports a printed antenna (41) made up of at least one turn and supports an integrated circuit module (10) connected to said antenna by two internal and external contacts (43, 44) located in the continuation of the internal and external extremities (45, 46), respectively, of the antenna turns, said module being located on the card in a portion defined by a first side (6) of the card, and a second side (8) of the card perpendicular to the first side, a first line (3) parallel to said first side (6) of the card and a second line (4) parallel to said second side of the card,
characterised in that said internal end (45) of the antenna turns connected to said internal contact (43) is located entirely in said portion in such a way that when the card is subjected to bending and/or twisting stresses, the connection between the module and the antenna is not broken, and in that said contacts (43, 44) are made by printing of at least two layers of an electrically conductive ink onto said support (40), the fist layer of ink (43-1) including spaces (47) not covered with ink.

2. The card according to claim 1, wherein the continuation (49) of said end (45) crosses said line (3), said end (45) crosses said axis (3) and their intersection is located as far away as possible on the card of said internal edge (23) of said module (10).

3. The card according to claim 1, wherein said end (45) is located in the continuation of the part of said internal contact (43) located inside the module.

4. The card according to claim 1, wherein the second and following layers of the first component layer (43-1) of said contact (43) have the same surface area as that of the component layers of said contact (44).

5. The card according to claim 1, wherein the thickness of said contacts (43, 44) is between 50 μm and 80 μm.

6. The card according to claim 5, wherein said antenna (41) and said module (10) are encased in the polyvinyl chloride (PVC) (61) of the layer of the card body located on the first face of said supporting layer (40), the first face being that on which said antenna is printed.

7. The card according to claim 6, wherein the second face of the supporting layer (40) is covered by a layer of polyesters (PET) (62).

8. The card according to claim 1, wherein said layer of PVC (61) is covered by a layer of PET (63).
